(19) United States
(12) Patent Application Publication
(10) Pub. No.: US 2013/0309053 A1
(43) Pub. Date: Nov. 21, 2013

(54) BOAT LOADER

(71) Applicant: Rodney Ian Cameron, Moama (AU)

(72) Inventor: Rodney Ian Cameron, Moama (AU)

(21) Appl. No.: 13/832,587

(22) Filed: Mar. 15, 2013

(30) Foreign Application Priority Data
May 18, 2012 (AU) 2012902051

(51) Int. Cl. B60P 3/10

(52) U.S. Cl. CPC B60P 3/1025
USPC 414/537

(57) ABSTRACT

A boat loader for loading and/or unloading a lightweight recreational boat onto and from a suitable vehicle to enable the boat to be transported between locations. The boat loader includes two loaders temporarily connectable between the rear of the vehicle and part of a trailer upon which the boat is located on either side of the trailer to guide movement of the trailer and hence the boat, for loading and unloading. The boat and the trailer moves as a single unit during loading and unloading so that the boat can be carried on the trailer on the vehicle during transportation of the boat. The advantage of the boat loader is that the boat remains in its normal hull down orientation and does not need to be inverted to enable it to be transported in a stable configuration.

### FIELD OF INVENTION

The present invention relates generally to a carrier device, apparatus or system for carrying or transporting an item from one location to another location.

In one form, the scope of protection relates to a carrier apparatus for moving an item between a first configuration and a second configuration in which the item is carried by the carrier apparatus in one of the configurations.

In one form, the present invention relates to a carrier apparatus for moving an item in which the carrier apparatus is convertible between a first configuration and a second configuration in which the item is carried from one location to another location by the carrier apparatus when in one or both of the two configurations.

In one form, the present invention relates to a carrier apparatus for moving an item between different configurations in which the item comprises two or more separate parts such that movement of one part of the item results in movement of the second part of the item.

One form of the present invention finds particular application as a boat loader for loading a boat onto the roof of a motor vehicle to allow transportation of the boat between different locations in which the boat loader facilitates loading of the boat onto and unloading the boat from the roof of the vehicle.

Although the present invention will be described with particular reference to one form of the carrier apparatus, it is to be noted that the scope of protection is not restricted to the described embodiment but rather the scope of protection is more extensive so as to include other forms and arrangements of the carrier apparatus including other forms and arrangements of the various components of the carrier apparatus, and the use of the various forms in applications and for purposes other than described.

### BACKGROUND OF INVENTION

Boats, particularly smaller boats such as for example, boats made from aluminium, are often used for recreation purposes, such as for example, fishing, duck hunting and similar pursuits on inland waterways. The boats are lightweight being made from aluminium and are generally of a welded construction and are usually provided with a generally low powered outboard motor which is detachably mountable to the rear or transom of the boat for use when required. Such boats which are primarily used for access to fishing locations and other recreational pursuits are often referred to as “tinnies”, “car toppers” or similar descriptions due to the material from which the boats are made or how they are transported between different locations or even how they are stored. Usually the boats are carried on a customised boat trailer dedicated to carrying the particular size, type, style of boat or the boats are carried on the roof of a vehicle, such as for example, a roof rack or similar, to allow access to the edge of a waterway in which the boat is to be used, such as for example, a river, lake, estuary, pond or similar.

When a trailer is used to transport the boat between different locations, the trailer must be of a type and construction which is sufficiently robust to withstand the rigors of road use, and must be compliant with the rules and regulations relevant to boat trailers in some countries, since boat trailers require registration for use on the public roads. Complying with these requirements increases the cost and weight of the trailers, making their transportation other than on the road more problematical.

If a boat is transported on the roof of a vehicle, it is usually transported in an inverted orientation for stability during transportation when the vehicle is being driven on the public roads since the waist of the boat will usually be the widest part of the load, and hence forms the base of the boat for transportation. Due to the need to carry the boat in an inverted orientation, it is usually necessary to have a complex lifting arrangement in order to be able to invert the boat either after or during raising of the boat onto the roof of the vehicle and when lowering the boat from the roof of the vehicle. The compound movement of lifting and inverting or lowering and inverting have added to the complexity of any lifting apparatus. To date, such existing lifting arrangements have not been satisfactory for one or other reason, including complexity, weight, maintenance and type, which often requires manhandling of the boat, and/or manually inverting the boat to locate the boat on the vehicle in a stable inverted orientation. Further, existing lifting apparatus lift the boat only onto and from the roof of the vehicle so that the boat requires manhandling at, at least some of the stages of raising and lowering the boat, in order to invert the boat to the stable carrying position on the roof of the vehicle. Thus, there is a need for a boat loader or similar which does not require the boat to be inverted for safely transporting the boat during the raising and lowering operations.

In many instances, access to a favourite fishing spot using a trailer to convey the boat is difficult because of the terrain or absence of a boat ramp or similar. Therefore, in many instances, it is not possible to launch a boat from a trailer directly into the water, but rather the trailer needs to be unhitched from the vehicle and then manhandled from a convenient location on a track, road, pathway or similar along which access for the vehicle towing the trailer is possible, to the edge of the waterway to enable the boat to be launched directly into the waterway. Thus, there is often a need to have a trailer to move the boat directly into and from the water, particularly in difficult terrain.

One attempt to overcome the difficulty in accessing the edge of the waterway is to transport the boat on the vehicle, such as on the roof of the vehicle. Whilst this method of transporting the boat allows access closer to the edge of the waterway, it presents difficulties of loading the boat onto the roof of the vehicle and unloading the boat from the roof into the water since, whilst the boats are lightweight, they are usually heavier than can be easily lifted by one or even two persons. Additionally, if access to the edge of the waterway is impossible, denied or difficult, the boat being carried on the roof needs to be dragged or otherwise manhandled from the vehicle to the waterway, which is often beyond the capability of the number of occupants of the boat, particularly in challenging terrain, and can result in injury to the people or damage to the boat or both. Thus, it is often necessary to have a trailer to transport the boat from the vehicle to the water's edge and vice versa.

Therefore, there is a need for an arrangement, apparatus or device enabling access to the waterway from a position which is as close as possible to the edge of the waterway for launching the boat but which does not involve having to manhandle the boat, such as lifting and/or carrying the boat, either between the vehicle and the waterway or when loading or unloading the boat onto or off the vehicle.

Accordingly, it is one aim of the present invention to provide a carrying system or carrying apparatus which allows a boat to be readily carried on a vehicle.

Accordingly, it is an aim of the present invention to provide a carrying system or carrying apparatus in the form of a loading assembly for use in loading an item onto the roof of a vehicle and/or for unloading an item from the roof of a vehicle.

Accordingly, it is one aim of the present invention to provide a carrying system, apparatus or device for moving an item onto and/or from a vehicle as a single unit or assembly, when the item comprises at least two components.

Accordingly, it is an aim of the present invention to provide a boat loader which allows a boat to be loaded onto and/or unloaded from a vehicle whilst remaining mounted on a boat trailer by loading and/or unloading the boat and trailer combination as a single unit.

Accordingly, it is an aim of the present invention to provide a method for moving a boat onto and/or from a motor vehicle to transport the boat from one location to another location.

Accordingly, it is an aim of the present invention to provide a guiding arrangement for use in assisting movement of a boat onto and/or from a motor vehicle.

Accordingly, it is an aim of the present invention to provide a boat loading arrangement which reduces or eliminates the need for the boat to be manually lifted either during raising and/or lowering of the boat from the vehicle and/or transporting the boat to and/or from the vehicle.

Accordingly, it is an aim of the present invention to raise and/or lower a boat and trailer unit or combination onto and/or from a motor vehicle without inverting the boat for adapting a stable transportation configuration.

It is to be noted that no all embodiments of the invention will satisfy all aims. Some embodiments will satisfy one aim, further embodiments will satisfy all aims. Some embodiments will satisfy two or more aims.

### SUMMARY OF INVENTION

According to one form of the present invention, there is provided a guide arrangement for guiding movement of an item between a first configuration and a second configuration, the guide arrangement comprising a first part capable of being connected to a part of a vehicle, a second part capable of being connected to the item, either directly or indirectly, the item being movable with respect to the vehicle between the first and second configurations in response to movement of the guide arrangement, when the item is caused to move, wherein the first part of the guide arrangement and the second part of the guide arrangement are interconnected to each other so that the first part and the second part move relatively with respect to each other to guide movement of the item between the first and second configurations.

According to one form of the present invention, there is provided an item comprising a first portion and a second portion, the first portion being separable from the second portion, the first portion and the second portion being capable of being connected to one another to allow movement of the first portion and second portion in unison, said item being capable of being connected to a guiding arrangement for guiding movement of the item in use, said guiding arrangement being connectable to the first portion or second portion of the item so that when the item moves, the guiding arrangement undergoes corresponding movement so as to guide movement of the item between a first configuration and a second configuration.

According to one form of the present invention, there is provided a carrier apparatus for moving an item with respect to a vehicle comprising a drive arrangement for providing a driving force to operate the carrier apparatus, a connecting arrangement for drivingly connecting the item to the drive arrangement, a guiding arrangement having a first part connectable to the vehicle and a second part connectable to the item for guiding movement of the item between a first configuration and a second configuration wherein the guiding arrangement moves in response to movement of the connecting arrangement when driven by the drive arrangement to guide movement of the item between the first and second configurations.

According to one form of the present invention, there is provided a method of moving an item between a first configuration and a second configuration, both configurations being in respect to a vehicle, comprising connecting a first part of a connecting member to a part of the item either directly or indirectly, connecting a second part of the connecting member to a drive arrangement, attaching a first part of a guide arrangement to a part of the vehicle, attaching a second part of the guide arrangement to a part of the item, such that the guide arrangement extends between the vehicle and item for guiding movement of the item with respect to the vehicle in use, operating the drive arrangement to drivingly move the connecting element, wherein the guide arrangement moves in respect to the connecting arrangement when driven by the drive arrangement to facilitate movement of the item between the first configuration and second configuration so that movement of the item causes movement of the guiding arrangement to guidingly move the item between the first and second configuration.

### BRIEF DESCRIPTION OF EMBODIMENTS

In one form, the carrier arrangement or system includes a transportation apparatus for carrying an item, typically between one location and another location. Typically, the transportation apparatus is or includes a loading/unloading assembly for loading the item onto a carrier. More typically the loading/unloading assembly is a lifting assembly for lifting the item and/or for lowering the item such as for example, between a first configuration and a second configuration. In one form, the carrying arrangement includes a lifting assembly which is mounted, at least in part, on the roof of a vehicle which is used to transport the item from one location to another location.

In one form, the item is a transportable item, object, article or similar that is transportable on the roof of a mobile carrier or similar. Typically, the carrier includes part of a motor vehicle. More typically, the motor vehicle is provided with a carrier assembly or a load carrying structure, such as for example, in the form of a roof rack, roof bars, or similar roof structure. In one form, the roof structure includes a group of transverse cross-members and a pair of longitudinal frame work members interconnected together, optionally with a mesh floor, typically a powder coated aluminium mesh floor.

In one form, the item is a boat, preferably a boat and trailer combination, even more preferably a boat and boat trailer combination in which the first portion of the item is the boat and the second portion of the item is the boat trailer. In one form, the boat is a lightweight boat made from aluminium or other lightweight alloy, including a boat made from a lightweight alloy or aluminium of a welded construction or similar.

One form of the boat trailer is a lightweight boat trailer, made from aluminium members or other lightweight alloy members interconnected to each other, such as by being welded together to form the boat trailer.

In one form, the carrier arrangement is a boat loader for loading the boat and boat trailer combination as a single unit, a single entity, or together in unison, onto the roof of a motor vehicle and unloading the boat and trailer combination as a single unit or entity from the roof of the motor vehicle. In one form, the trailer is lifted and loaded with the boat securely attached to the trailer, typically in the upright position or in the normal in use position, i.e. the right way up and not inverted. Preferably, the boat is located on the roof of the vehicle in the normal use position which is the position in which the hull of the boat is lowermost on the roof of the vehicle.

In one form, the first configuration is when the item is in an unloaded configuration in which the boat/trailer combination is located adjacent the vehicle such as for example, on the roadway, ground or similar beside or to one end of the vehicle, at the same level as the motor vehicle, typically, in preparation for being loaded onto the vehicle and/or just being retrieved from the waterway, such as via a ramp or similar.

On one form, the second configuration is a loaded configuration in which the boat/trailer combination is located on the roof of the vehicle in preparation for or during transportation from one location to another location, such as for example, from home to a waterway using the public roads.

In one form, movement from the unloaded configuration to the loaded configuration involves elevating the boat/trailer combination from the ground level to the level of the roof or roof rack of the vehicle. In one form, the movement from the second or loaded configuration to the first or unloaded configuration involves unloading the boat/trailer combination as a single unit from the roof or roof rack of the vehicle onto the ground typically while the boat is located upon the trailer, so that the boat can be rolled to the waterway on the trailer or the boat can be launched from the trailer on a boat ramp or similar located at the edge of the waterway.

In one form, the guiding arrangement includes at least one guide member, guide element or similar for guiding movement of the boat/trailer unit as a single unit is being loaded and/or unloaded by constraining free movement of the boat/trailer unit. Typically, the guide member comprises two or more guiding elements and is in the form of a loader. In one form, the guide elements of the loader are movable with respect to one another, typically telescopically movable with respect to each other in the lengthwise extending direction of the loader. Typically, the guide elements are part of a telescopic arrangement in which one element is telescopically received within the other element so that the length of the guiding arrangement or loader is variable depending upon the position of the boat/trailer combination or unit with respect to the motor vehicle, such as for example, during the loading and/or unloading operations, the length of the guiding elements or loader changes. In one form, the guide members are provided with a bearing, bushing, spacer, or similar between them to facilitate sliding movement of one member with respect to the other member.

In one form, the guide elements or loader is/are provided with couplings or connectors for connecting the guide elements or loader to the vehicle and to the boat/trailer combination or unit. Typically, the connectors are guide connectors or guide couplings which allow movement of the guide elements, typically pivotal movement, rotational movement, or similar in which the movement has more than a single degree of freedom of movement or type of movement. In one form, the guide connectors allow pivotal motion as well as rotational motion. More typically, the guide connectors or couplings are rod and bearings, universal joints, ball joints, Heim joints, rose joints or similar having an outer cage or housing and an inner ball bearing or similar. In one form, each connecting element forming the connecting member is provided with a rod and bearing or swivel joint coupling or similar at one end thereof. Typically, the swivel coupling is located at or towards the ends of the loader element, and includes an outer member and an inner element in which the outer member is fixed to the connecting element and the inner element is free to move with respect to the outer member, more typically, by both rotational movement and pivotal movement. Typically, the guide elements are releasably connectable to the vehicle and/or boat/trailer unit at a suitable or convenient location. More typically, the coupling or connector of the guide element is releasably connectable.

In one form, the guide elements or loader is fixed, such as for example, fixed to part of the vehicle, preferably to the rear of the vehicle and more preferably, to the top of the rear of the vehicle. In one form, the guide element is a track or skid bracket, typically the track is in the form of a channel, along which the wheels of the trailer can roll or otherwise traverse from one end to the other end to raise and/or lower the trailer when loading/unloading the boat.

In one form, the skid bracket or channel is a foldable bracket, capable of being folded for storage. In one form, there is provided a support for the skid bracket or channel typically in the form of a support leg for supporting the skid bracket or track, typically about to midpoint of the bracket. In one form the midpoint leg contacts the ground to support the channel.

In one form, one end of one guide element having the coupling or connector is connected to the vehicle, typically to the rear portion of the vehicle, even more typically to a towing arrangement, and preferably to a part of a tow bar or part of the chassis member or platform member of the vehicle to anchor one end of the guide arrangement.

In one form, the towing arrangement is provided with a locator for locating the connecting member centrally with respect to the item. In one form, the locator is provided on the front of the trailer, typically attached to the towing hitch or to the drawbar, to maintain alignment of the trailer with respect to the vehicle by maintaining the position of the cable. In one form, the locator is a slot, notch, rebate, groove, depression or the like for receiving the cable therein. However, any suitable or convenient locator can be used.

In one form, the locator is a movable locator, typically movable between an extended position for engaging with the cable to guide the cable and to protect the cable, and a retracted position in which the locator is clear of the towing apparatus allowing the trailer to be hitched to the vehicle by the hitch fitting over the towing ball. Preferably, the locator is in the form of a stainless steel bracket which is pivotally connected to the trailer, preferably the forward end of the drawbar to swivel between the extended position and the retracted position. One form of the bracket has two opposed sides of a generally U-shape concave configuration joined at their respective distal ends by a web in the form of a roller, and their respective proximal ends pivotally joined to either side of the central drawbar of the trailer.

In one form, the tow bar is provided with one or more projections for being received within the guide coupling or connector of the guide element to allow the guide member to be connected to the vehicle.

In one form, the trailer is provided with one or more projections for being received within the guide coupling of the guide member for connecting the guide member to the trailer.

In one form, the guide arrangement extends and/or retracts during movement of the loading assembly when raising and lowering the boat/trailer combination during use whilst the end of one of the guide elements remains connected to the rear of the vehicle and whilst the end of another of the guide elements remains connected to the boat/trailer unit to direct movement of the boat/trailer unit by maintaining the unit in alignment to be safely and securely received at home on the roof rack or roof structure.

In one form, the guide arrangement is temporarily attached to the vehicle and/or temporarily attached to the boat/trailer combination for use when the boat/trailer combination is being loaded and/or unloaded for at least a part of the duration of the loading and/or unloading procedure.

In one form, the guiding arrangement or guide arrangement is a loader, loader rod, loader ram, loader arm, loader device or similar. Typically, the loader is stored on or about the roof of the vehicle when not in use, more typically, on the roof rack or similar fixedly attached to the roof of the vehicle.

In one form, the drive arrangement is a motor or comprises a motor. The motor can be any suitable motor including an hydraulic motor, electric motor, air motor or similar. Typically, the motor is an electrically operated winch, preferably a 12 volt motorised winch or similar having a motor and a rotating drum. In one form the winch is mounted to the roof rack or roof structure located on the top of the motor vehicle, typically, a full size four wheel drive vehicle, camper trailer, caravan, or similar. More typically, in some vehicles, the winch is positioned at or towards the front of the roof rack, whereas in other vehicles the winch is mounted at or towards the rear of the vehicle.

In one form, the connecting arrangement includes an interconnection member, an interconnection element, a transmission or transmission member or element, or similar for transmitting movement of the drive member to the boat/trailer unit. In one form, the interconnection member is a flexible member. Typically, the flexible member is a wire, cable, rope or similar. In one form, the interconnection member is a wire rope wound or received around the drum of the electric winch.

In one form, the free or distal end of the wire cable or rope is connectable to the boat or to the trailer, typically to the rear of the trailer, for effecting movement of the boat and trailer in unison. Typically the free end of the cable is provided with a releasable fastener, typically in the form of a hook, shackle, snap shackle, karabiner or similar, which is connectable to the rear cross-member of the trailer.

In one form, there is a directing arrangement or aligning arrangement for directing the movement of the connecting member in use. In one form, the directing arrangement is located at or towards the rear of the roof structure, vehicle of the like. Typically, the directing arrangement includes a rotating element for engaging with the interconnection element. More typically, the rotating element is a wheel, such as for example, a pulley wheel having two opposed flanges, or a roller, such as a boat roller, flat roller or similar. In one preferred form, the rotating element is a configuration of a pulley wheel and one or more boat rollers in which the pulley wheel is located coaxially with and intermediate the two rollers so as to be used to centre the cable during use.

### BRIEF DESCRIPTION OF THE DRAWINGS

An embodiment of the present invention will now be described to illustrate a form of the invention by way of example only with reference to the accompanying drawings in which:

FIG. 1 is a schematic isometric view of one embodiment of motor vehicle and boat and trailer combination in one configuration.

FIG. 2 is an enlarged view of circle A of FIG. 1.

FIG. 3 is an enlarged view of circle B of FIG. 1.

FIG. 4 is an enlarged view of circle C of FIG. 1 showing the attachment of one end of the guiding arrangement to the motor vehicle.

FIG. 5 is an enlarged view of circle D of FIG. 1.

FIG. 6 is an enlarged view of circle E of FIG. 1.

FIG. 7 is an isometric view of one form of a guide member showing axial movement of two components between a partially extended position and a partially retracted position.

FIG. 8 is an exploded view of one form of a wheel assembly and method of mounting/demounting the wheel assembly to the trailer chassis.

FIG. 9 is an isometric view showing one form of the wheel assembly connected to the chassis of the trailer and one form of hull support in a detached condition.

FIG. 10 is a schematic side elevation view of the boat/trailer combination connected to the tow bar of a motor vehicle prior to being loaded onto the roof of the vehicle.

FIG. 11 is a similar view to FIG. 10 showing the boat/trailer combination in a partially raised position.

FIG. 12 is a view similar to FIG. 10 showing the boat/trailer combination in a further raised position.

FIG. 13 is a view similar to FIG. 10 showing the boat/trailer combination in a further raised position prior to pivoting onto the roof of a vehicle.

FIG. 14 is a view similar to FIG. 13 showing the boat/trailer combination being supported on the roof of the vehicle but before the combination moves to its final at rest position.

FIG. 15 is a schematic side elevation view of the trailer/boat combination at rest on the top of the motor vehicle in a fully loaded configuration.

FIG. 16 is an isometric view of one form of the locator in the form of a pivoting bracket in an extended position.

FIG. 17 is an isometric view of the pivoting bracket of FIG. 16 in a retracted position.

### DESCRIPTION OF SPECIFIC EMBODIMENT

One form of an embodiment of the invention will now be described with reference to the accompanying drawings by way of illustration of one example of the carrier apparatus in the form of a boat loader.

As a general overview of this embodiment, there is provided a motor vehicle, generally denoted as 10, which includes road wheels 12 of which one or both pair are driving wheels, a generally rectangular roof rack or roof carrier 14 located on the top of vehicle 10 and a towing arrangement, in the form of a tow bar arrangement 16, provided with a towing ball or similar, located at the rear of vehicle 10, typically centrally located at the rear of vehicle 10. Vehicle 10 is used to transport an item, typically in the form of a boat 30 and a trailer 22, as a unitary boat and trailer unit or combination from one location to another location over the public road system when the boat/trailer unit is mounted on the roof of vehicle 10.

A boat trailer, generally denoted as 22, is hitched to towing arrangement 16 in use for towing trailer 22 as required, such as for example, over relatively short distances, not necessarily using the public road system, such as for example, along the driveway or approach road providing access to a boat ramp to launch boat 30. However, other forms of the trailer can be road registered and be provided with equipment, including legal road wheels, allowing the trailer to be operated at normal vehicle speeds on the public road.

A boat, generally denoted as 30, is located on trailer 22 for being carried or otherwise conveyed by trailer 22 as needed. Trailer 22 is provided with a pair of spaced apart road wheel assemblies 26 allowing movement of trailer 22 over shorter or longer distances as required.

It is to be noted that the illustrated version of trailer 22 and boat 30 combination are usually towed only short distances to enable the boat to be launched into the waterway from a suitable location, such as a boat ramp or similar (not shown) and is not primarily designed to transport the boat over relatively long distances using the public road system, such as for example, from the waterway to the house or building in which the boat is stored. Thus, in this form, trailer 22 and wheel assemblies 26 are made from relatively light weight materials and uses a relatively lightweight construction. However, in other forms, the trailer can be fully compliant to be used at speed on the public roads to transport the boat over longer distances if required, such as for example, being equipped with mudguards, lights and similar.

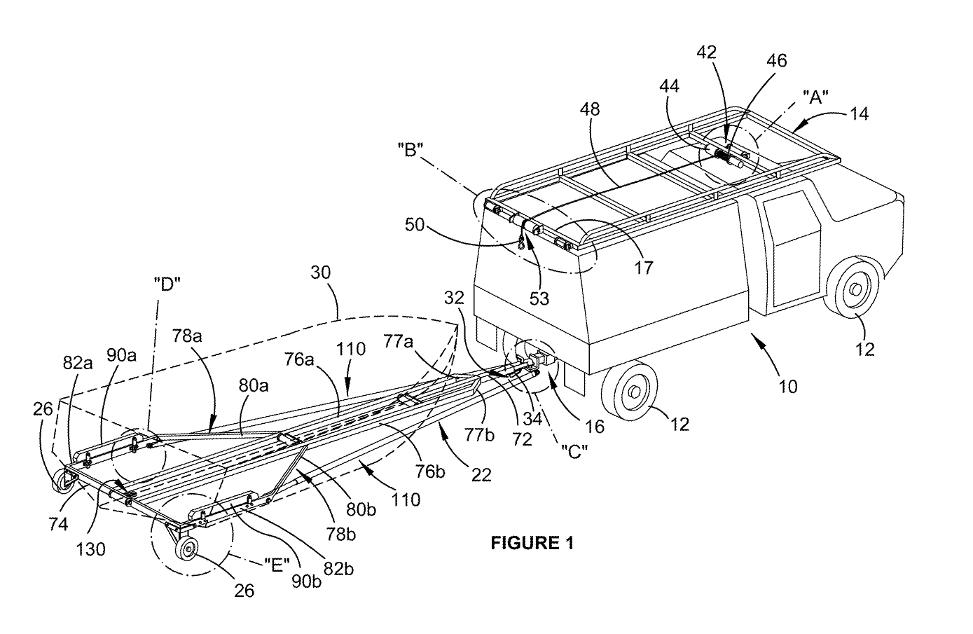

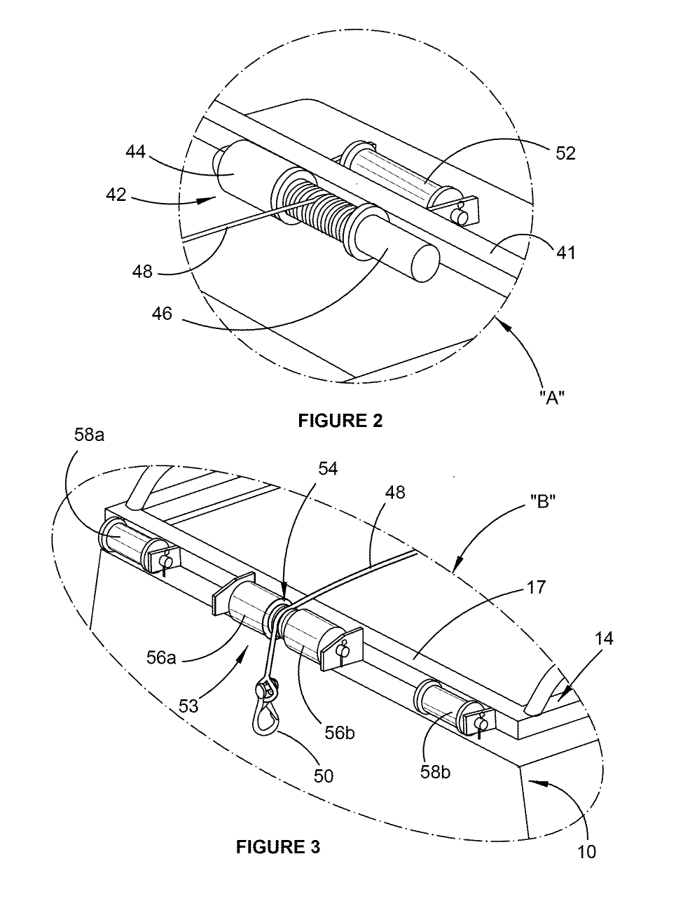

Turning now to motor vehicle 10, in one form, vehicle 10 is provided with a roof structure or roof rack 14 fixedly located at or to the top of vehicle 10. In one form, the roof rack 14 extends longitudinally to a length greater than the length of the roof of vehicle 10, such as for example, as shown in FIG. 1, and is provided with a forward portion which extends over the driving cab or compartment of vehicle 10 as shown more particularly in FIG. 1. The forward portion includes a front transverse roof rack cross-member 41. In other forms, the roof rack extends along the roof line only so there is no front extension of the roof rack over the front of the vehicle.

In another form, the vehicle is a caravan, such as for example, a fold down caravan, a pop-up caravan, a camper trailer or the like having a roof capable of being lower when in a transport mode or raised when in a stationary use mode. Any suitable vehicle may be used with the boat loader of the invention. In one form, roof rack 14 is provided with a base or platform, such as a mesh bed (not shown) to assist in transporting other equipment.

A motorised winch 42 is provided at or towards the front of the roof rack 14 in use, such as in the forward portion where it is fixedly connected to transverse cross-member 41. In one form, winch 42 includes a motor 44, a winding drum 46, and a length of wire cable or winch rope 48, terminating in a releasably securable fastener in the form of a shackle or hook 50. In operation, motor 44 is energised from a suitable power source such as the storage battery of the vehicle or an auxiliary storage battery provided within the vehicle to operate winch 42, to rotate drum 46 which draws in or plays out wire cable 48 as required for loading or unloading respectively, boat 30.

A forward boat roller 52 is located at or towards the front of roof rack 14, typically centrally mounted on transverse cross-member 41. Roller 52 can be of any suitable type, size or composition to assist in movement of boat 30 when on roof rack 14 and to assist in securing boat 30 on trailer 22 when on the roof of the vehicle, such as for example, transportation of boat 30 and trailer 22 as a unit.

With particular reference to FIG. 3, the rear end of roof rack 14 will now be described. The free end of wire cable 48 provided with hook 50 is received over a support and directing arrangement generally denoted as 53 provided on rear cross-member 17 of roof rack 14. In one form, arrangement 53 includes a central pulley wheel 54 located intermediate rear rollers 56a, 56b, located centrally of rear cross-member 17 to direct the direction of movement of wire cable 48. In one form, pulley wheel 54 is sized to receive wire cable 48 there around so that wire cable 48 is located and retained within the gap or space of central pulley wheel 54 defined by the two spaced apart flanges of pulley wheel 54, when cable 48 is being wound out or wound in on drum 46. Rollers 56a, 56b support the weight of boat 30 whilst boat 30 and trailer 22 are being loaded and unloaded. In one form, central pulley wheel 54 has two opposed flanges in face-to-face relationship with each other. The flanges are shaped so as to receive wire cable 48 therein to control the direction of movement of the cable in use.

In one form, central pulley wheel 54 and rollers 56a, 56b are separate items whereas in another form, there is a single integrated unit having a circular groove located intermediate two rollers formed as an integral unit coaxially arranged on a common axle with the rollers tapering inwards towards the central circular groove. Pulley wheel 54 is preferably made from stainless steel. In operation, central pulley wheel 54 permits movement of wire cable 48 and guides the direction of movement of wire cable 48 in use, and accordingly the direction of movement of trailer 22 and boat 30 as will be described later. A roller 58a, 58b is located outboard on either side of rear member 17 of roof rack 14 to assist in supporting the weight of the boat and trailer combination as the combination is being loaded and unloaded. Rollers 58 can be of any suitable size, shape, profile or type, including a cylindrical roller, a flat roller.

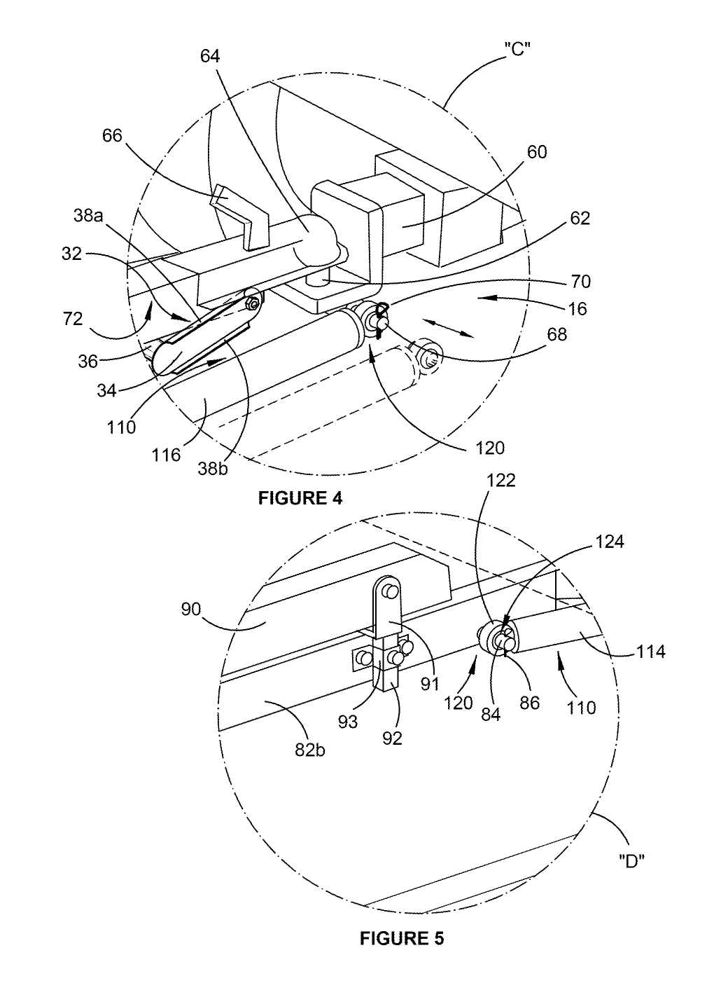

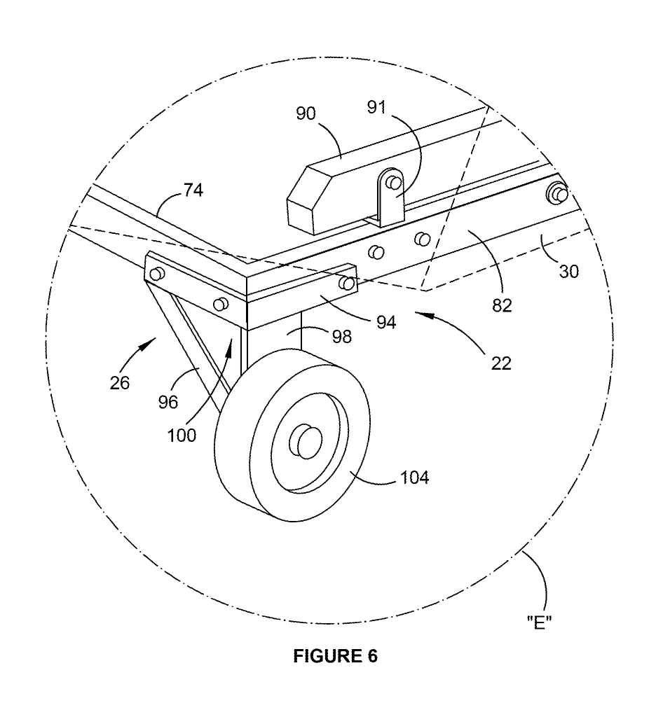

In one form, towing arrangement 16 includes a tow bar having a towing neck 60 to which a towing ball 62 is fixedly connected for receiving a towing hitch 64 of trailer 22 there over for connecting trailer 22 to vehicle 10 allowing for pivotal movement of trailer 22 with respect to vehicle 10 during use of the vehicle and trailer combination, such as for short distances to and from a boat ramp or over the public road system. In one form, towing hitch 64 of trailer 22 is a conventional hitch of the type used to connect a trailer to a motor vehicle using a tow ball or similar and is provided with a locking handle 66 to lock hitch 64 on tow ball 62. The towing arrangement 16 is provided with a outwardly extending arm or similar projection in the form of a pin or stub 68 on either side of neck 60 of towing arrangement 16 to act as attachment points for a guiding arrangement to be described in more detail later. Although there are two stubs 68, only one stub 68 is illustrated in the drawings. Each stub 68 is provided with a transverse bore at or towards the distal end for receiving therethrough a clip, such as a spring clip 70, to retain one end of the guiding arrangement on the stub. One form of the towing arrangement 16 is shown more particularly in FIG. 4.

Hitch 64 is provided with a locator for locating the position of wire cable 48 in contact with hitch 64 during use. Typically, the locator is provided on the forward facing side or edge of hitch 64 or on the lower surface of hitch 64, or both. In one form, the locator is a slot, groove, notch, rebate, channel or similar depression for receiving cable 48 therein on the forward facing edge of hitch 64 to maintain the position of the cable with respect to the trailer during raising and lowering of the boat/trailer unit.

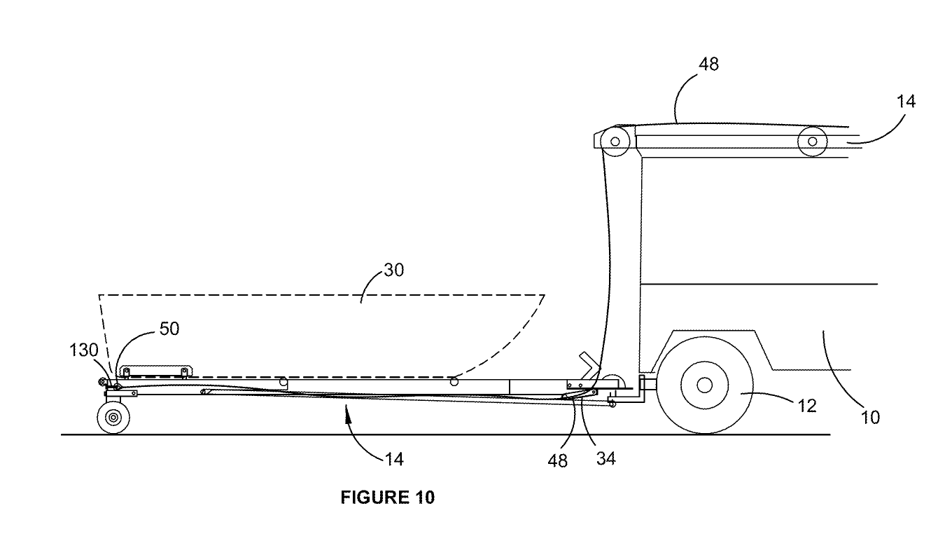

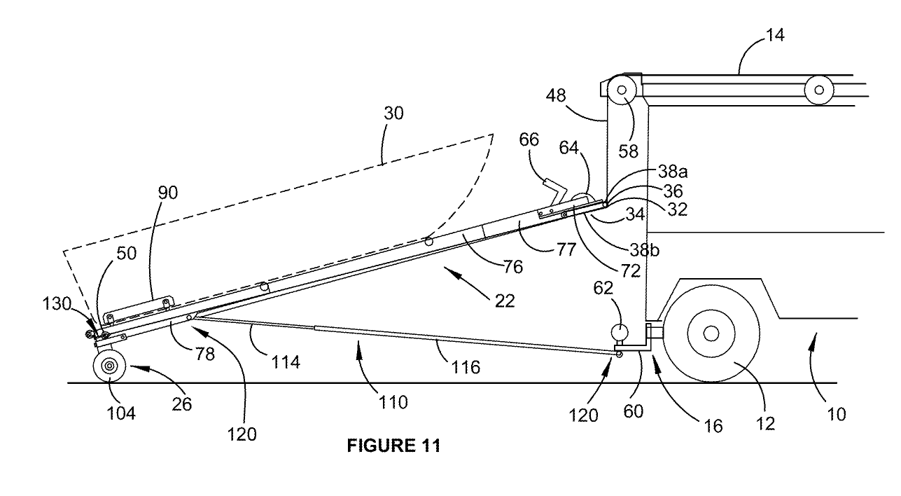

Another form of the locator is in the form of a pivotal stainless steel bracket 32 having a generally U-shape comprising two generally concave side walls 34 pivotally connected at one end to either side of drawbar 72 of trailer 22 to allow swivelling movement between an extended position as shown in FIG. 11 and a retracted position as shown in FIGS. 4 and 10. The distal ends of the bracket are interconnected by a web in the form of a drum, roller, rod or the like having a curved surface 36. In use, cable 48 is guided over the curved surface of roller 36 which is located between walls 34 formed by the sides of the bracket. After use, bracket 32 can be pivoted to reside under drawbar 72 clear of towing hitch 64.

One form of the trailer 22 and boat 30 combination, in the form of a single unit comprising both will now be described.

Trailer 22 comprises a central lengthwise extending chassis member in the form of a central drawbar 72 extending from the front of the trailer where hitch 64 is connected to the draw bar to the rear of the trailer where it is connected to rear cross-member 74 of trailer 22. A pair of generally elongate braces 76a, 76b are arranged to extend substantially parallel to central drawbar 72 by one brace member 76a, being located on one side of central drawbar 72 and the other brace member 76b being located on the other side of the central drawbar 72 as shown more particularly in FIG. 1. In one form, each brace member 76 has a short angularly inclined forward section 77a, 77b where each brace joins central drawbar 72. Trailer 22 includes a first generally lengthwise extending outer member in the form of near-side outer rail 78a, located on one side of trailer 22, and a second generally lengthwise extending outer member in the form of off-side outer rail 78b, on the other side of trailer 22 to form part of the chassis or support substructure of trailer 22 for supporting boat 30 thereon. In one form, each outer rail 78a, 78b is generally bent having two portions angularly inclined to each other being forward outer portions 80a, 80b and rear outer portions 82a, 82b inclined at a generally obtuse angle with respect to each other. The forward end of forward portions 80a, 80b are fixedly connected to the respective outer rails 78 whereas the rear end of rear portions 82a, 82b are fixedly connected to the respective ends of rear cross-member 74. In one form, each rear portion 82a, 82b of each outer chassis member 78a, 78b, is provided with an outwardly extending arm in the form of a spigot or similar 84a, 84b, which extends outwardly from the outer facing side of the respective rear portions of each outer chassis members 78a, 78b. It is to be noted that only one spigot 84a is illustrated in the drawings. The other spigot 84b which is on the other side of trailer 20 is substantially identical to spigot 84a. The outwardly extending spigot 84 is for receiving an end of the guiding arrangement to connect the guiding arrangement to the trailer (to be described later). Spigot 84 is provided with a transverse bore for receiving therethrough a releasable fastener, in the form of a spring clip 86 or similar to secure one end of the guiding arrangement securely to the trailer by retaining the end of the guiding arrangement on spigot 84. In another embodiment, spigot 84 is located to extend inboard of trailer 22 so that the guiding arrangement extends more inwardly of trailer 22.

A pair of removably demounted cradle members are provided one on either side of trailer 22. In one form, the cradle members are boat hull skids or trailer skids 90a, 90b for supporting respective sides of the hull of boat 30 when boat 30 is located on trailer 22. In one form, trailer skids 90 are removable from the trailer using a locking arrangement between the skids and the outer chassis members. In one form, the locking arrangement includes a yoke 91, locking pin 92 and a bracket 93 for retaining the locking pin, as shown more particularly in FIG. 5.

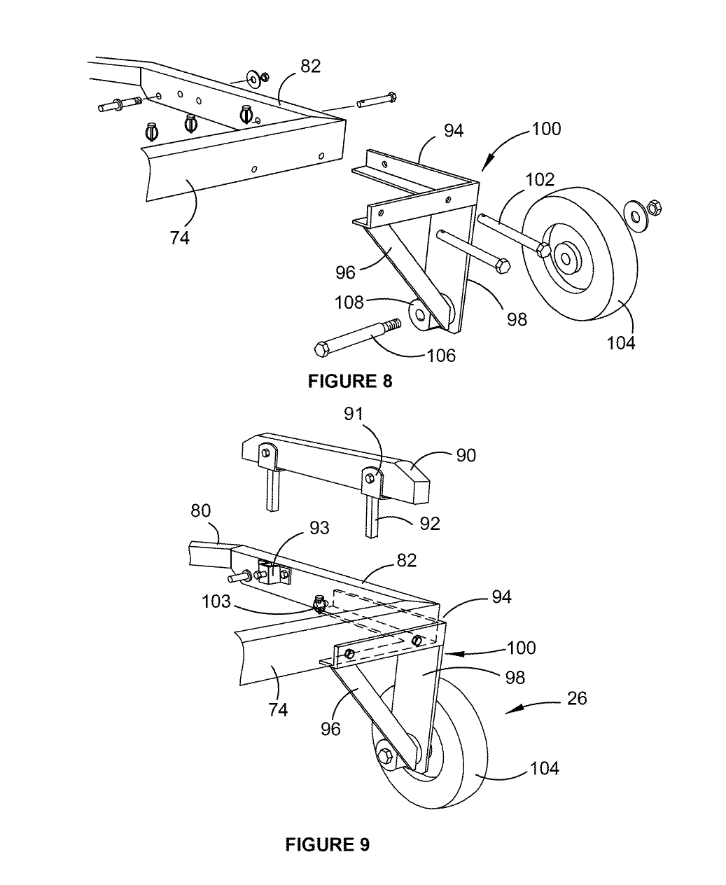

A wheel assembly 26 is provided on either side of trailer 22 at or towards the rear of trailer 22. In one form, the wheel assembly 26 is removably connectable to the rear of trailer 22 by a releasably securable fastening system as shown more particularly in FIGS. 8 and 9 which includes pins and clips at strategic locations. However, in other forms, the road wheels of the trailer may be more or less permanently fixed in position on trailer 20, particularly if the wheel assembly includes road registrable wheels, such as for example, 8 inch aluminium wheels or similar.

In one form, wheel assembly 26 includes a frame arrangement having three members 94, 96, 98 arranged to extend substantially perpendicular to each other forming a substantially three dimension right angle bracket 100 having three legs and an inclined brace extending between two of the members for attaching to the rear corner of trailer 22 made up of rear cross-member 74 and rear portion 82 of outer rail 76 using pins 102 for being received through aligned apertures. Pins 102 are held in place through the apertures by a split spring clip 103 or similar fastener being received in transverse bores located at or towards the free end or distal ends of pins 102. A wheel 104 is demountably attached to bracket 100 at or towards the distal ends of bracket members 96, 98 29 to support trailer 22 (and boat 30 thereon) when the trailer is being manoeuvred. Wheel 104 is connected to bracket 100 by axle 106 received in bush 108 or similar. It is to be noted that wheel assembly 26 is readily demountable from either side of the rear of trailer 22. Wheel 104 can be of any suitable or convenient type, such as for example, a road wheel that is compliant for use on the road, a trailer wheel, a lightweight wheel, or the like optionally fitted with a pneumatic inner tube.

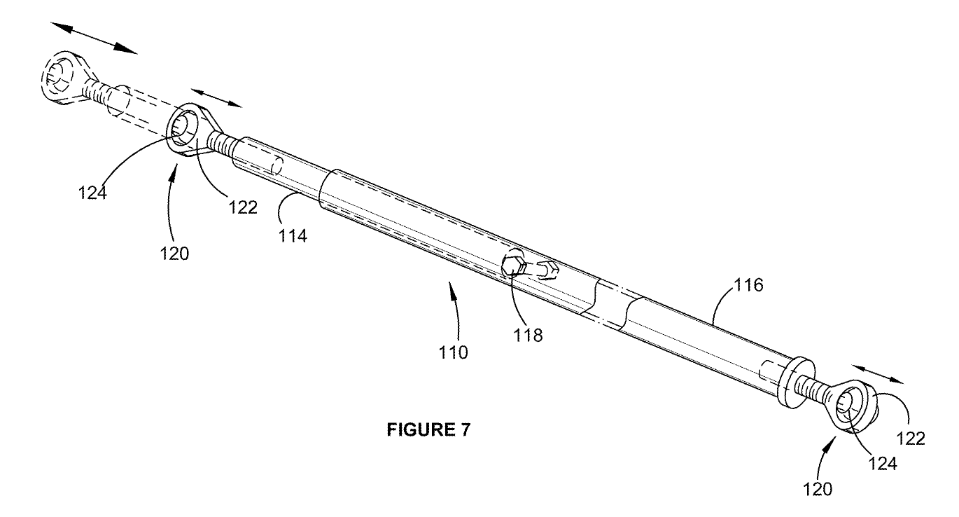

One form of the guide arrangement for use in guiding movement of the boat loader during use to load and unload the boat/trailer unit, will now be described. One form of a guide arrangement 110 is releasably mounted on either side of trailer 22 for guiding movement of trailer 22 and accordingly boat 30 during the loading and unloading operations. One end, being the forward end, in use of guide arrangement in the form of a loader 110, is pivotally connected to stub 68 of neck 60 of the tow bar arrangement 16 of vehicle 10 whereas the other end of loader 110 is pivotally connected to spigot 86 located on rear portion 82 of outer rail 78 of trailer 22. One form of loader 110 has a first inner lengthwise extending rod 114 located within a second outer lengthwise extending hollow tube 116 so that the inner rod and outer tube are free to move telescopically with respect to each other to change the length of loader 110 as required during the loading/unloading operations. A stop in the form of a transverse bolt 118 is provided transversely through outer tube 116 to limit the axial movement of inner rod 114 by the proximal end of rod 114 contacting bolt 118 internally within tube 116. The position of bolt 118 is optionally adjustable in accordance with the type and size of vehicle and the type and size of trailer. A guide coupling or guide connector in the form of a rod end bearing, such as for example a ball joint, a rose joint rod end or a Heim joint 120 or similar is provided at the free end of rod 114 and at the free end of tube 116. One form of the guiding arrangement in the form of a loader, is shown in FIG. 7. In one form, rose joint 120 is provided with an outer housing in the form of a circular cage 122 and an inner movable bearing in the form of a ball swivel 124 or similar which is rotationally and pivotally movable with respect to outer cage 122 to allow guide 110 to move with respect to both trailer 22 and vehicle 10 in use. An opening is located centrally within the ball swivel for receiving stub 68 or spigot 84.

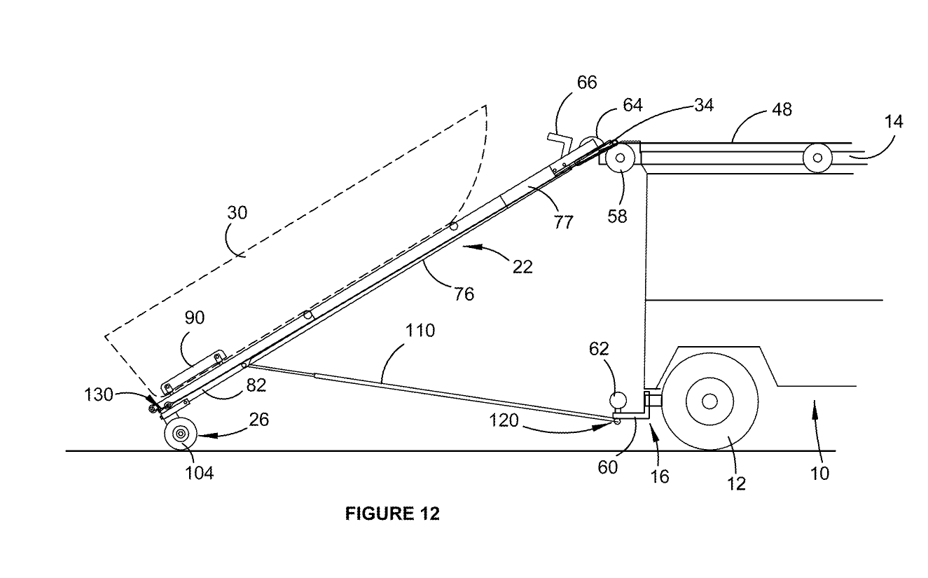

A clevis connector in the form of a U-bolt or similar 130 is provided on the rear transverse frame member 74 of trailer 22. In one form, U-bolt 130 extends inwardly from rear frame member 74. Hook 50 at the distal or free end of wire cable 48 is connected to the clevis pin of U-bolt 130 to secure the cable between the rear of trailer 22 and electric winch 42 mounted on roof rack 14. In one form, wire cable 48 extends from U-bolt 130 lengthways under the support substructure of trailer 22 comprising the central drawbar 72, side rails 76 and outer rails 78, from rear transverse member 74 to the front of the trailer underneath towing hitch 64 around the locator provided on the forward facing part of hitch 64 in the form of pivotal bracket 32 to extend upwardly along the rear of vehicle 10 over pulley 54 along roof rack 14 to winch 42 where it is wound around drum 46 as shown more particularly in FIG. 10. After trailer 22 is disconnected from vehicle 10 by hitch 64 being disengaged from tow ball 62, and pivotal bracket 32 moved to the extended position, cable 48 can be withdrawn onto drum 46 of winch 42 which draws the rear of the trailer towards the vehicle and simultaneously lifts the front of the trailer which rises about the rear of the vehicle in accordance with the continued movement of the cable. The rear of the trailer rolls towards the vehicle on wheels 104 of wheel assembly 26 as the front of the trailer is lifted as shown more particularly in FIG. 11. Guide members or loaders 110 on either side of the trailer, guide movement of the trailer and allow the trailer to be raised to an intermediate raised position in alignment with vehicle 10 as the position of cable 48 is directed by cable 48 being received around pulley 54 as shown more particularly in FIG. 11 as being in a partially raised position, and in or through bracket 32 provided on hitch 64. As the wire cable is further retracted, the top of the trailer is raised to engage rear cross-member 17 of roof rack 14 such that towing hitch 64 of trailer 22 is located over the central pulley 54 as shown more particularly in FIG. 12 as the boat and trailer unit are moved to a further raised position.

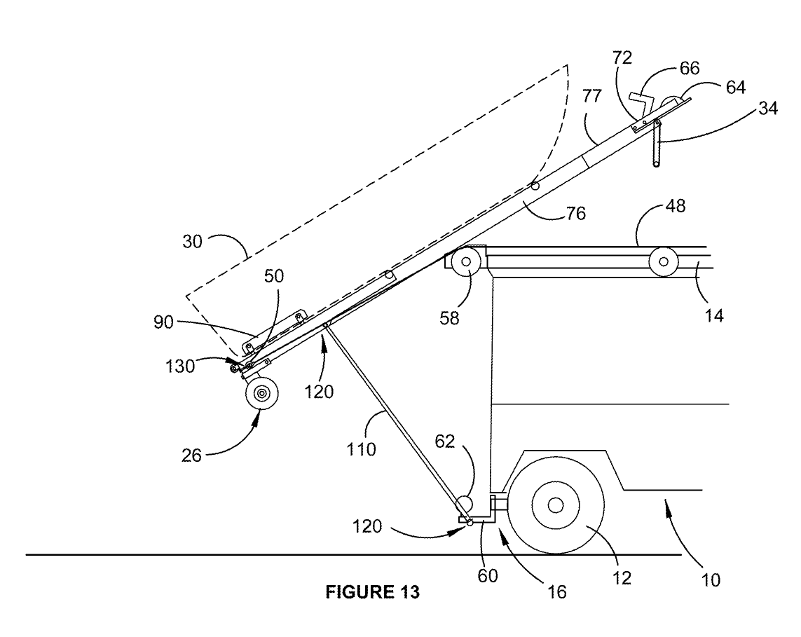

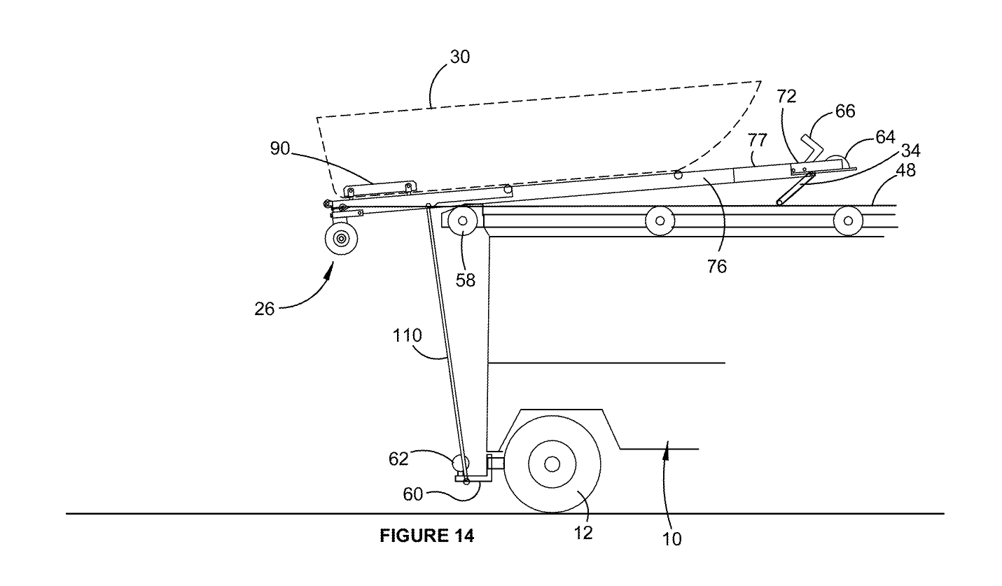

When the guiding arrangement or loader 110 is in the fully retracted position with the proximal end of inner rod 114 against bolt 118 acting as a stop preventing further retraction of the guide arrangement as the cable continues to be withdrawn, the rear of the trailer begins to rise and is pivoted upwardly by the pivoting action of guiding arrangement or loader 110 about spigots 84 on either side of the trailer and about stubs 68 on either side of towing neck 60 as the respective ball joints 124 rotate within housing 122 owing to guide coupling 120 which allows the end of loader 110 to rotate until the trailer and boat combination is raised to such an extent that the weight of the trailer and boat is supported by the roof rack with the trailer angled in an oblique direction with the trailer angularly inclined to the roof rack as shown more particularly in FIG. 13 in an even more further raised position. When the centre of gravity of the boat and trailer combination is forward of the rear of the roof rack, typically, more forward of rear cross-member 17 and pulley 54, the trailer pivots under the effect of gravity so that the front of the boat and trailer fall in unison onto the roof rack such that the front of the trailer moves downwardly whilst the rear of the trailer moves upwardly to adopt a position as shown in FIG. 14 which is a position corresponding to the fully raised position. In this position, the entire weight of the trailer and boat unit is supported on the roof rack. When the boat/trailer unit is in this position, both loaders 110 can be removed by disconnecting couplings 120 at both ends of loader 110 respectively from the trailer and from the vehicle for storage on or about roof rack 14 (not shown). Additionally, wheel assemblies 26 can also be demounted from the rear of trailer 22 to lighten the weight of the boat/trailer unit when being transported on the roof of the vehicle.

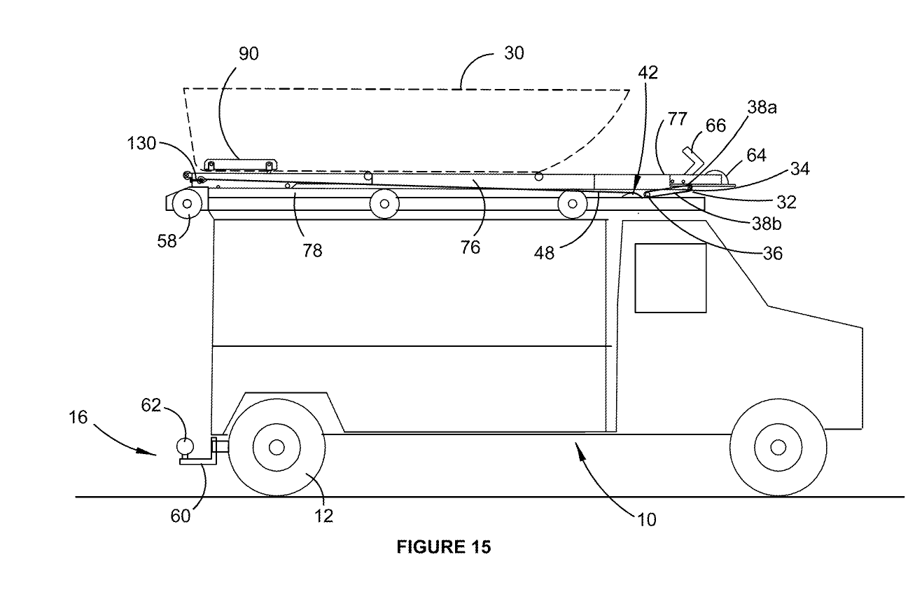

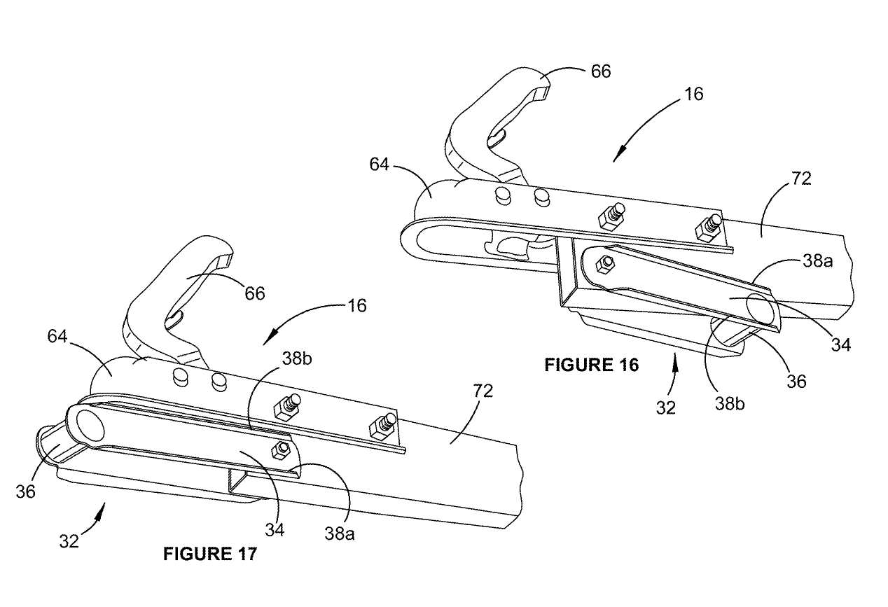

Winch 42 is further operated to drag the boat/trailer unit to a more forward position which is the loaded position as shown more particularly in FIG. 15 in which the boat/trailer unit is stably supported on the roof rack with the bow of the boat resting on forward roller 52. In this position, vehicle 10 can be driven from one location to another location to transport the boat/trailer unit.

When the boat/trailer unit is to be unloaded from the vehicle, the reverse operation to that described previously occurs. The boat/trailer unit is released from the roof rack and dragged or allowed to fall rearward under the effect of gravity, for a short distance to release the boat trailer unit by operation of the electric winch playing out cable 48 to release the boat and trailer. At the appropriate position of the boat trailer unit, two loaders 110 are connected between the towing arrangement at respective one ends and the trailer at the respective other ends to allow for guided unloading of the trailer and boat from the top of the vehicle. The trailer road wheel assemblies 26 are also connected to the rear of trailer 22. Winch 42 is then further operated to play out further length of cable 48 to allow the boat/trailer unit to be lowered from the top of vehicle 10 towards ground level, using loaders 110 as pivots so that the boat/trailer unit is lowered in an arc away from the rear of the vehicle towards the roadway. When the boat and trailer are on the ground at the same level as the vehicle, loaders 110 are removed from the vehicle and trailer and the trailer can be attached to the vehicle using the towing arrangement, and manoeuvred to the edge of the waterway or onto the boat ramp or the boat can be launched directly into the waterway from the trailer.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

### ADVANTAGES

Using the boat loader for raising the boat/trailer unit as a single unit allows the boat to remain right way up at all times, which allows the boat to be used for storage of lightweight items, such as for example, life jackets, fishing gear, wet weather clothing, fishing paraphernalia generally, or the like.

Depending upon the weight of the boat/trailer unit and the roof carrying capacity of the vehicle, in some circumstances, the motor can remain attached to the boat at all times during the loading and unloading operations and when transporting the boat on the vehicle.

No lifting and/or manhandling of heavy components is required using the boat loader of the present invention.

One button operation of the electric winch is possible using a remote control apparatus for operating the winch.

The time taken to launch and retrieve the boat is less than when the boat is inverted on the roof of the vehicle as the boat does not need to be put the right way before it can be used or inverted when it is to be loaded onto the vehicle.

As the boat and trailer can be loaded/unloaded as a single unit there is no need to place the boat on the trailer to transport the boat when on the ground.

The boat trailer can be used as a normal boat trailer for transporting the boat as and when required.

We claim:

1. A guide arrangement for guiding movement of an item between a first configuration and a second configuration, the guide arrangement comprising a first part capable of being connected to a part of a vehicle, a second part capable of being connected to the item, either directly or indirectly, the item being movable with respect to the vehicle between the first and second configurations in response to movement of the guide arrangement, wherein the first part of the guide arrangement and the second part of the guide arrangement are interconnected to each other so that the first part and the second part move relatively with respect to each other to move the item between the first and second configurations when the guide arrangement moves.

2. An item comprising a first portion and a second portion, the first portion being separable from the second portion, the first portion and the second portion being capable of being connected to one another to allow movement of the first portion and second portion in unison, said item being capable of being connected to a guiding arrangement for guiding movement of the item in use, one part of the guiding arrangement being connectable to the first portion or second portion of the item and another part of the guiding arrangement being connectable at a fixed location so that when the item moves, the guiding arrangement undergoes corresponding movement so as to guide movement of the item between a first configuration and a second configuration.

3. A carrier apparatus for moving an item with respect to a vehicle comprising a drive arrangement for providing a driving force to operate the carrier apparatus, a connecting arrangement for drivingly connecting the item to the drive arrangement, a guiding arrangement having a first part connectable to the vehicle and a second part connectable to the item for guiding movement of the item between a first configuration and a second configuration wherein the first part and the second part of the guiding arrangement move with respect to each other in response to movement of the connecting arrangement when driven by the drive arrangement to guide movement of the item between the first and second configurations.

4. A method of moving an item between a first configuration and a second configuration, both configurations being in respect to a vehicle, comprising connecting a first part of a connecting member to a part of the item either directly or indirectly, connecting a second part of the connecting member to a drive arrangement, attaching a first part of a guide arrangement to a part of the vehicle, attaching a second part of the guide arrangement to a part of the item, such that the guide arrangement extends between the vehicle and item for guiding movement of the item with respect to the vehicle in use, operating the drive arrangement to drivingly move the connecting element, wherein the guide arrangement moves in response to movement of the connecting arrangement when driven by the drive arrangement to facilitate movement of the item between the first configuration and second configuration so as to move the item with respect to the vehicle.

5. A carrier apparatus according to claim 3 in the form of a boat loader for use in loading a boat onto a vehicle and for unloading a boat from a vehicle.

6. A carrier apparatus according to claim 5 in which the motor vehicle is provided with a carrying assembly in the form of a roof structure located on the roof of the vehicle in which the roof structure is in the form of a roof rack, roof bars, carry bars or other load carrying roof structure.

7. A carrier apparatus according to claim 3 in which the item is a boat or a boat and trailer combination in which the boat and trailer combination is loaded and/or unloaded onto and/or form the vehicle as a single unit with the boat attached to the trailer in the usual transportation mode so that the boat remains in an orientation in which the hull is in contact with the trailer.

8. A carrier apparatus according to claim 6 which is convertible between a first configuration and a second configuration wherein the first configuration is when the boat or boat/trailer combination is in an unloaded configuration located on the ground or next to the vehicle and the second configuration is a loaded configuration in which the boat or boat/trailer combination is located on the roof of the vehicle or on the roof structure attached to the vehicle in the form of a roof rack.

9. A carrier apparatus according to claim 8 in which the guiding arrangement includes at least one guide member, guide element, or guide part for guiding movement of the boat and trailer unit when loading and/or unloading the boat and trailer unit by constraining movement of the boat and trailer unit to guided movement between the loaded configuration and the unloaded configuration.

10. A carrier apparatus according to claim 3 in which the guide member comprises two or more moveable guiding elements, movable with respect to each other to convert the guiding member between two different operating configurations being a generally extended configuration and a generally retracted configuration.

11. A guiding apparatus according to claim 3 in which the guide arrangement are loaders comprising two or more guide elements, telescopically movable with respect to each other to alter the length of the loader in accordance with the position adopted by the boat/trailer unit with respect to the vehicle during the loading and/or unloading operation.

12. A guiding arrangement according to claim 11 in which the loader is provided with a bearing, bushing, spacer or similar located between the guide elements to facilitate sliding movement of one element with respect to the other element as the boat/trailer unit moves, and a stop member for limiting retraction of the two guide elements with respect to each other so that the loader moves as a unit between the vehicle and the boat/trailer unit to cause movement of the boat/trailer unit between the loaded and unloaded positions.

13. A guiding arrangement according to claim 12 in which the loader is substantially elongate and is provided with couplings or connectors at either end for connecting one of the guide elements to the vehicle at one end and another of the guide elements to the boat/trailer combination or unit at the other end so that the loader extends between the vehicle and the boat/trailer unit.

14. A guiding arrangement according to claim 13 in which the connectors are guide connectors or guide couplings allowing movement of the respective guide elements to the vehicle and/or boat/trailer unit during the loading and/or unloading operation.

15. A carrier apparatus according to claim 14 in which movement of the guide connectors or guide couplings is pivotal movement or rotational movement, or both pivotal and rotational movement for enabling guiding movement of the boat/trailer unit.

16. A carrier apparatus according to claim 15 in which the guide connector allows pivotal motion in one plane of movement as well as rotational motion in another plane of movement.

17. A carrier apparatus according to claim 16 in which the loader is provided with a rod and bearing or swivel joint coupling at one end thereof in which the swivel coupling includes and outer member and an inner member in which the outer member is fixed to the connecting element and the inner member is free to move with respect to the outer member.

18. A carrier apparatus according to claim 17 in which the guide connector or guide couplings are rod and bearings, universal joints, ball joints, Heim joints, rose joints, having an outer cage or housing which is stationery and an inner ball bearing which is movable with respect to the cage or housing for providing movement of the guide connector.

19. A carrier apparatus according to claim 18 in which the coupling member or connector of the guide element is releasably connectable to the trailer and/or to the vehicle.

20. A carrier apparatus according to claim 19 in which one end of one guide element having the guide coupling or connector is connected to the rear portion of the vehicle, preferably to the towing arrangement and more preferably to projections extending outwardly from the tow bar of the towing arrangement to anchor one end of the guide arrangement.

21. A carrier apparatus according to claim 20 in which the towing arrangement is provided with a locator for locating the connecting member centrally to the boat and trailer unit.

22. A carrier apparatus according to claim 21 in which the locator is a slot, notch, rebate, groove, or depression, for receiving the connecting member therein or therethrough for driving movement of the boat/trailer unit.

23. A carrier apparatus according to claim 21 in which the locator is a movable bracket pivotally movable between an extended position for contacting the connecting member and a retracted position in which the bracket is clear of the towing apparatus for allowing the trailer to be hitched to the vehicle.

24. A carrier apparatus according to claim 23 in which the bracket is provided with at least one concave side, preferably a pair of concave sides, more preferably an opposed pair of concave sides, and a web interconnecting respective one ends of the two concave sides.

25. A carrier apparatus according to claim 20 in which the guide arrangement is temporarily attached to the vehicle and/or is temporarily attached to the boat/trailer unit for use during the loading and/or unloading operations of the boat trailer combination.

26. A carrier apparatus according to claim 23 in which the connecting member is a flexible interconnecting member or flexible interconnection element.

27. A carrier apparatus according to claim 26 in which the flexible interconnecting member or element is a wire, cable, rope, cord, or similar including a coated wire or the like having a protective coating, in which the movement of the cable is caused by rotation of a winch to move the cable by the cable being wound around or played out from the drum of the winch.

28. A carrier apparatus according to claim 3 further comprising a directing arrangement or aligning arrangement for directing movement of the connecting member in alignment in use, wherein the directing arrangement is located at or towards the rear of the roof structure or roof of the vehicle.

29. A carrier apparatus according to claim 28 in which the directing arrangement includes a rotating element for engaging with the connecting element, said rotating element being in the form of a wheel, pulley wheel, roller and the interconnection element being in the form of a cable in which the cable is located within a slot or groove of the wheel, pulley wheel, roller or similar.

30. A carrier apparatus according to claim 1 in which the guide arrangement is a pair of guide members such that one guide member is located on one side of the boat and trailer unit and the other guide member is located on the other side of the boat and trailer unit.
